(19) United States
(12) Patent Application Publication
(10) Pub. No.: US 2015/0068190 A1
(43) Pub. Date: Mar. 12, 2015

(54) THRUST REVERSER WITH A DEPLOYMENT-CONTROLLED BLOCKING FLAP

(71) Applicant: AIRCELLE, Gonfreville L'Orcher (FR)

(72) Inventors: Christian ROGER, Sainte Adresse (FR); Philipe GUERIN, Le Havre (FR)

(21) Appl. No.: 14/535,444

(22) Filed: Nov. 7, 2014

Related U.S. Application Data
(63) Continuation of application No. PCT/FR2013/050968, filed on May 2, 2013.

(30) Foreign Application Priority Data
May 10, 2012 (FR) 12/54260

(51) Int. Cl. F02K 1/76; F02K 1/68

(52) U.S. Cl. CPC F02K 1/763; F02K 1/68
USPC 60/226.2

(57) ABSTRACT

A thrust reverser device for a turbojet engine nacelle includes a mobile cowl movably mounted to translate between a closed position which the mobile cowl covers grids deflecting some of the air flow of the turbojet engine and an open position in which it opens a passage and uncovers the grids. The mobile cowl is associated with a blocking flap to pivot between a retracted position and a blocking position corresponding to the open position of the mobile cowl. The blocking flap is fitted with at least one lever forming a drive mechanism which includes at least one adjustable-stiffness shock absorber.

### CROSS-REFERENCE TO RELATED APPLICATIONS

This application is a continuation of International Application No. PCT/FR2013/050968, filed on May 2, 2013, which claims the benefit of FR 12/54260, filed on May 10, 2012. The disclosures of the above applications are incorporated herein by reference.

### FIELD

The present disclosure relates to a thrust reverser called grid thrust reverser for a turbojet engine nacelle.

### BACKGROUND

The statements in this section merely provide background information related to the present disclosure and may not constitute prior art.

An aircraft is powered by several turbojet engines each housed in a nacelle also accommodating a set of annex actuating devices related to its operation and providing various functions when the turbojet engine is in operation or at shutdown.

These annex actuating devices comprise in particular a thrust reversal mechanical system.

Such a nacelle generally has a tubular structure comprising an air inlet upstream of the turbojet engine, a mid-section intended to surround a turbojet engine fan, a downstream section accommodating the thrust reversal means and intended to surround the combustion chamber of the turbojet engine, and may end with an ejection nozzle the outlet of which is located downstream of the turbojet engine.

Modern nacelles are intended to accommodate a bypass turbojet engine capable of generating via the blades of the rotating fan a hot air flow (also called primary flow) from the combustion chamber of the turbojet engine and a cold air flow (secondary flow) which circulates outside of the turbojet engine through an annular passage, also called path, formed between a fairing of the turbojet engine and an inner wall of the nacelle. The two air flows are ejected from the turbojet engine form the rear of the nacelle.

The role of a thrust reverser device, during landing of an aircraft, is to improve its braking ability by redirecting forward at least a part of the thrust generated by the turbojet engine.

In this phase, the thrust reverser obstructs the cold flow path and directs the latter to the front of the nacelle, thereby generating a counter-thrust which adds to the braking of the wheels of the aircraft.

The means implemented to achieve this cold flow reorientation vary depending on the thrust reverser type. However, in all cases, the structure of a thrust reverser comprises movable cowls displaceable between, on the one hand, a deployed position in which they open a passage within the nacelle intended for the diverted flow, and on the other hand, a stowed position in which they close this passage and provide the aerodynamic continuity of the nacelle.

These cowls may fulfill a function of deflection or simply of actuation of other diverting means.

In the case of a grid thrust reverser, also called cascade-type thrust reverser, the reorientation of the air flow is performed by diverting grids, the cowl having only a simple sliding function aiming to uncover (activate) or cover (deactivate) these grids.

Complementary blocking doors, also called flaps, activated by the sliding of the movable cowl generally allow at least a partial closing of the path downstream of the diverting grids so as to force the passage of the air flow toward the grids.

These flaps are pivotally mounted on the sliding cowl between a retracted position in which they provide, with said movable cowl, the aerodynamic continuity of the inner wall of the nacelle, and a deployed position in which, in a thrust reversal situation, they obstruct at least partially the annular channel in order to divert a gas flow toward the diverting grids uncovered by the sliding of the movable cowl.

The pivoting of the flaps is guided by fastened connecting rods, on the one hand, to the flap, and on the other hand, to a fixed point of the inner structure delimiting the annular channel.

Such configurations of the prior art have several problems and in particular problems of different opening kinematics between the translation of the cowling and the pivoting of the flaps.

This issue of the kinematics of the opening degree of the flaps relative to the sliding of the cowl affects the management of the total passage section of air and is a particularly significant aspect.

Indeed, during a transition phase between the opening and closing of the thrust reverser, the opening of the flaps, in the beginning of the opening phase of the movable cowl, is quicker than the recoil of said cowl.

There is often a sensitive kinematic point which places the flap in a partial obstruction position of the annular channel without the complete compensation of the obstructed section by the upstream section uncovered by the recoil of the movable cowl.

The upstream passage section through the grids of the thrust reverser being lower at the section of the path which is obstructed by the flaps, this results in an increase of the pressure in the engine, thus implying a delicate management of the rotational speed of the turbojet engine in this transient phase.

Several solutions have been set up so as to bring solutions to this problem.

There are in particular known solutions allowing the implementation of some delay at the opening of the blocking flaps, thus preventing such a pressure increase in the path.

However, in case of a too significant delay at the opening, the reverse situation, in which the upstream passage section of air through the grids added to those of the direct jet flow is considerably higher than the inlet section of air, occurs. This situation causes a pressure decrease in the turbojet engine, which is also detrimental thereto.

For example, one may mention the document FR 2 952 128.

The proposed mechanical systems, although addressing at least partially the mentioned problem, have limitations in terms of adaptability, adjustment, reliability and overall size, in particular in a nacelle having a reduced available space.

Thus, there is still a need for a more flexible driving system allowing a precise and reliable adjustment of the opening kinematics of these blocking flaps.

### SUMMARY

The present disclosure provides a thrust reversal device for a turbojet engine nacelle comprising at least one cowl movably mounted in translation along a direction substantially parallel to a longitudinal axis of the nacelle between a closing position in which it provides an aerodynamic continuity of the nacelle and covers diverting means of at least a part of an air flow of the turbojet engine, and an opening position in which it opens a passage in the nacelle and uncovers said diverting means, the movable cowl being associated with at least one blocking flap pivotally mounted between a retracted position corresponding to the closing position of the movable cowl and a pivoted blocking position corresponding to the opening position of the movable cowl and in which it obstructs at least partially an air circulation path of the nacelle, the blocking flap being equipped with at least one driving mechanism forming a lever, characterized in that the driving mechanism comprises at least one adjustable-stiffness damper.

Thus, by equipping the driving mechanism of the blocking flap with an adjustable-stiffness damper, it is possible to precisely adjust the available lever length for the deployment or the retraction of said flap and consequently adapt the deployment or retraction kinematics of said flap.

In the case of the deployment of the flap for example, a low initial damping stiffness would allow an easy deployment of the rod of the damper. The available length of the lever might follow the deployment of the movable cowl which will not cause the pivoting of the flap.

When the movable cowl has been sufficiently deployed, it is then appropriate to increase the stiffness of the damper. By then, the rod of the latter can no longer be deployed in a so easy manner, and it limits the translation travel of the flap which hence starts pivoting. The same applies to the retraction.

According to a first form, the adjustable-stiffness damper is a damper with a variable-permeability piston.

In such a case, the stiffness variation is performed by varying the passage section of the fluid of the damper between the chambers separated by the piston.

Advantageously, the permeability variation of the piston of the damper is obtained via a first perforated disc capable of rotating in front of a second fixed perforated disc so as to cause a passage section variation through the piston.

In other form, the movable disc is driven in rotation in front of the fixed disc via at least one progressive groove extending along a body of the damper.

In still another form, the groove has a variable pitch according to the deployment law of the movable cowl of the thrust reverser.

According to a second form, the adjustable-stiffness damper is a magneto-rheological fluid damper.

In such a case, the stiffness variation is not performed by modifying the passage section of the fluid through the piston but by modifying its viscosity. Of course, for a better control, the two alternatives may be combined.

Advantageously, the device comprises at least one electronic regulation casing capable of controlling the viscosity of the magneto-rheological fluid of the damper.

Still advantageously, the electronic regulation casing is programmed to adapt the viscosity of the magneto-rheological fluid depending on an opening law of the movable cowl, in particular depending on at least one position sensor of said movable cowl.

Complementarily, the adjustable-stiffness damper is associated with at least one mechanical motion amplifier. This allows in particular keeping a relatively short and light damper.

Advantageously, the adjustable-stiffness damper comprises at least one spring and/or pneumatic accumulator aiming to compensate frictions at one head of the damper.

The present disclosure also relates to a turbojet engine nacelle, characterized in that it comprises at least one thrust reversal device according to the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1 and 2 are schematic representations of a first form of a thrust reversal device according to the present disclosure;

FIGS. 3 to 5 are schematic representations of a second form of a thrust reversal device according to the present disclosure; and

FIGS. 6 to 8 are schematic representations of a variable-permeability adjustable-stiffness damper system.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As previously explained, a thrust reversal device conventionally comprises a movable cowl 1 capable of being driven in translation by at least one cylinder 2 one end of which is mounted on a fixed front frame 4.

The thrust reversal device also comprises blocking flaps 5 pivotally mounted on the movable cowl via a first end.

The pivoting of the flap 5 is performed via a hinge mechanism comprising at least one connecting rod connected to a fixed portion of the thrust reverser, in this case the front frame 4.

In accordance with the present disclosure, the connecting rod is a variable-stiffness damper.

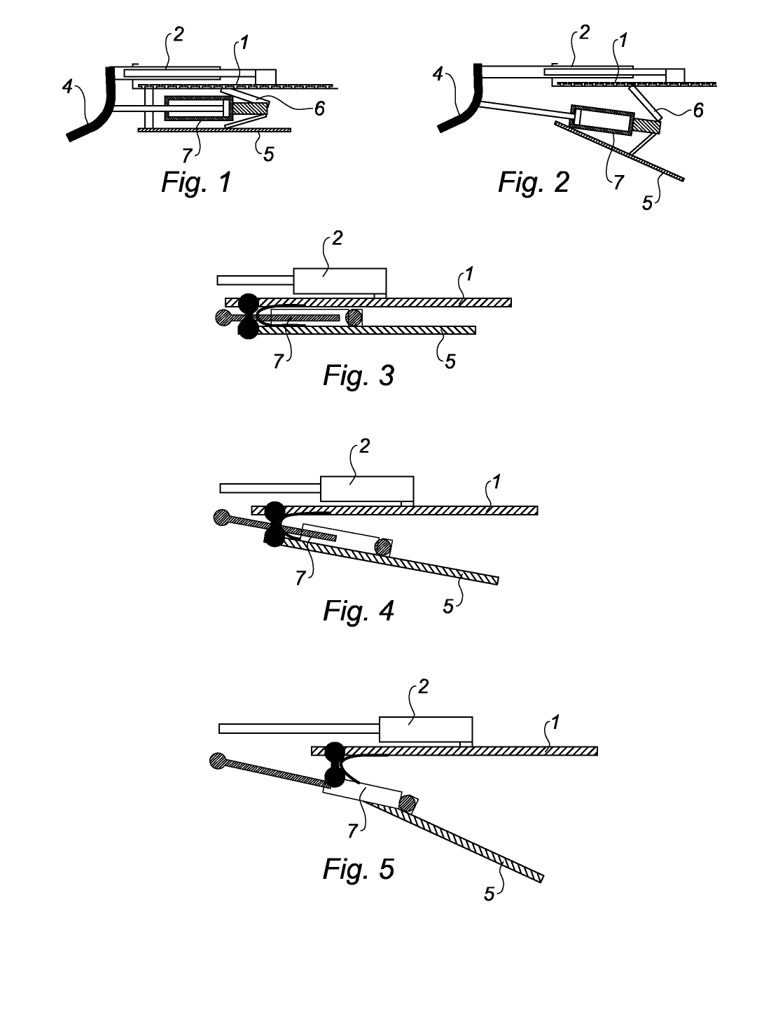

FIGS. 1 and 2 show a first form in which the hinge system of the flap 5 comprises a mechanical amplifying compass 6 mounted at a movable end of the connecting rod and having a first branch fastened to the movable cowl 1 and a second branch fastened to the flap 5.

The connecting rod is a magneto-rheological fluid damper 7.

In the beginning of the opening travel of the thrust reverser, the magneto-rheological liquid is maintained at a low viscosity, thus allowing the lengthening of the damper concomitantly with the displacement of the movable cowl 1.

When the movable cowl 1 reaches a sufficient opening degree, the viscosity of the magneto-rheological fluid is significantly increased until it strongly limits the deployment of the rod of the damper.

The damper is then no longer deployed with the recoil of the movable cowl, and has a fixed length which causes the flap 5 to pivot.

FIGS. 3 to 5 represent another form in which the flap 5 is directly connected to the magneto-rheological damper 7, thus performing a direct control of the opening of said flap 5.

Among the advantages brought by the magneto-rheological fluid dampers, it will be noted that they allow implementing a simple hinge mechanism, having reduced overall size and mass. Also, it may even be considered to modulate the deployment profiles on each engine independently.

A magneto-rheological fluid is also capable of seeing its rheological properties quite quickly modified during the application of the magnetic field, thus allowing complying with the safety constraints and obtaining a reactive system.

It will be noted that such magneto-rheological dampers do not have to dissipate energy. They are moreover relatively low energy consumers. A maximum electrical consumption of 75 watts during the active phases of the thrust reverser is estimated.

An electronic management casing (not represented) allows controlling the magnetic field applied to the fluid of the damper, and hence its viscosity. Such a management casing might be coupled with a position sensor of the rod of the damper or of the movable cowl.

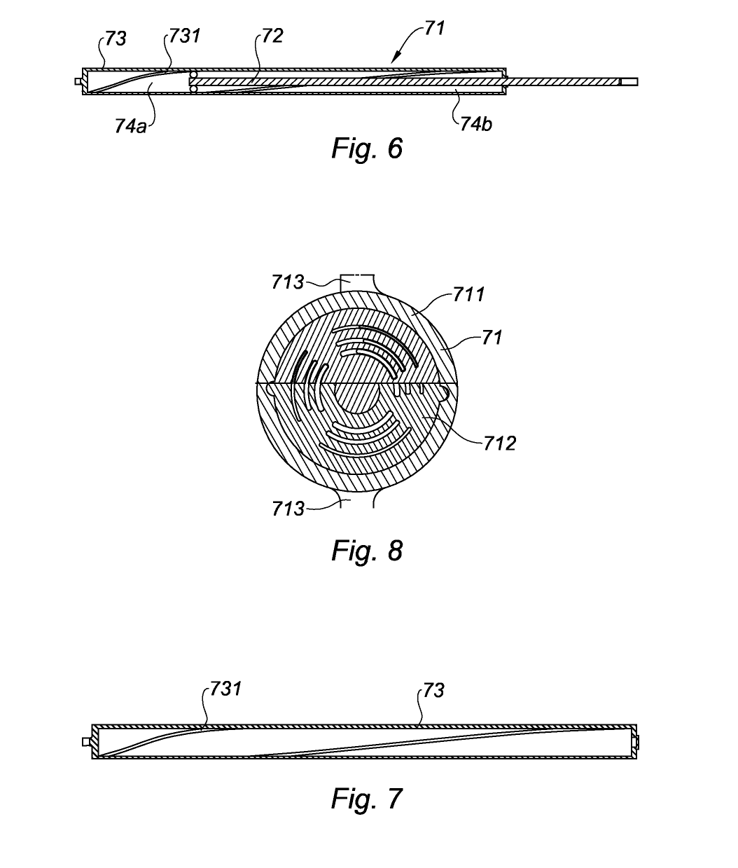

FIGS. 6 and 8 schematically present a mechanical form of an adjustable-stiffness damper.

More precisely, it comprises a damper 71 with a variable-permeability piston 72.

Such a damper conventionally comprises a body 73 inside of which a piston 71 is movably mounted.

This piston 71 separates the body 73 into two chambers 74a and 74b and allows the controlled passage of a damping fluid between the two chambers.

If the piston lets the fluid pass easily between the two chambers, the damper will be rather soft. Conversely, if the piston lets the fluid pass with difficulty, the damper will be stiffer.

In accordance with the present disclosure, the permeability of the piston 71, that is to say its ability to facilitate or not the passage of the fluid, is adjustable.

To do so, the piston 71 has a first perforated disc 711 capable of rotating in front of a second fixed perforated disc 712 so as to cause a variation in the passage section through said discs 711, 712.

The first disc 711 is driven in rotation via side fins 713 capable of cooperating with a groove 731 arranged inside the body 73 of the damper.

The profile of the groove will be provided depending on the desired opening profile for the flap 5.

Although the present disclosure has been described with a particular form, it is obvious that it is in no way limited thereto and that it comprises all technical equivalents of the described means as well as their combinations if they are within the scope of the present disclosure.

What is claimed is:

1. A thrust reversal device for a turbojet engine nacelle comprising:
at least one cowl movably mounted in translation between a closing position in which said cowl provides an aerodynamic continuity of the nacelle and covers diverting means for diverting at least a part of an air flow of a turbojet engine, and an opening position in which said cowl opens a passage in the nacelle and uncovers said diverting means, said at least one cowl being associated with at least one blocking flap pivotally mounted between a retracted position corresponding to the closing position of said cowl and a blocking position corresponding to the opening position of said cowl, in the blocking position,
wherein said at least one blocking flap obstructs at least partially an air circulation path of the nacelle, said blocking flap being equipped with at least one driving mechanism forming a lever, and said driving mechanism comprising at least one adjustable-stiffness damper.

2. The thrust reversal device according to claim 1, wherein said at least one adjustable-stiffness damper is a damper with a variable-permeability piston.

3. The thrust reversal device according to claim 2, wherein the variable-permeability piston is obtained via a first perforated disc configured to rotate in front of a second fixed perforated disc so as to cause a passage section variation through the variable-permeability piston.

4. The thrust reversal device according to claim 3, wherein the first perforated disc is driven in rotation in front of the second fixed perforated disc via at least one progressive groove extending along a body of said at least one adjustable-stiffness damper.

5. The thrust reversal device according to claim 4, wherein said at least one progressive groove has a variable pitch according to a deployment law of said at least one cowl.

6. The thrust reversal thrust reversal device according to claim 1, wherein the adjustable-stiffness damper is a magneto-rheological fluid damper.

7. The thrust reversal thrust reversal device according to claim 6, wherein said at least one blocking flap is directly connected to the magneto-rheological fluid damper so as to perform a direct control of said blocking flap.

8. The thrust reversal device according to claim 6, further comprising at least one electronic regulation casing configured to control viscosity of the magneto-rheological fluid damper.

9. The thrust reversal device according to claim 8, wherein said at least one electronic regulation casing is programmed to adapt the viscosity of the magneto-rheological fluid depending on an opening law of said at least one cowl.

10. The thrust reversal device according to claim 9, wherein said at least one electronic regulation casing is programmed to adapt the viscosity of the magneto-rheological fluid depending on at least one position sensor of said at least one cowl.

11. The thrust reversal thrust reversal device according to claim 1, wherein the adjustable-stiffness damper is associated with at least one mechanical motion amplifier.

12. The thrust reversal thrust reversal device according to claim 11, wherein said at least one mechanical motion amplifier is mounted at a movable end of a connecting rod of the adjustable-stiffness damper and comprises a first branch fastened to said at least one cowl and a second branch fastened to said at least one blocking flap.

13. The thrust reversal thrust reversal device according to claim 1, wherein the adjustable-stiffness damper comprises at least one of a spring and a pneumatic accumulator to compensate frictions at one head of the adjustable-stiffness damper.

14. A turbojet engine nacelle comprising at least one thrust reversal device according to claim 1.
